(19) United States
(12) Patent Application Publication
(10) Pub. No.: US 2023/0145556 A1
(43) Pub. Date: May 11, 2023

(54) BIDIRECTIONAL WINDOW SCREEN FOR A VEHICLE

(71) Applicants: HYUNDAI MOTOR COMPANY, Seou (KR); KIA CORPORATION, Seoul (KR)

(72) Inventor: Seung-Won Lee, Yongin-si (KR)

(73) Assignees: HYUNDAI MOTOR COMPANY, Seoul (KR); KIA CORPORATION, Seoul (KR)

(21) Appl. No.: 17/880,150

(22) Filed: Aug. 3, 2022

(30) Foreign Application Priority Data
Nov. 5, 2021 (KR) 10-2021-0151534

(51) Int. Cl. B60J 1/20

(52) U.S. Cl. CPC B60J 1/2052; B60J 1/2069; B60J 1/2063; B60J 1/2044; B60J 1/2047; B60J 1/2033

(57) ABSTRACT

The present disclosure relates to a bidirectional window screen for a vehicle, which can be independently deployed forward and backward, respectively, while moving in a longitudinal direction of a vehicle. The bidirectional window screen for the vehicle includes a guide having upper and lower ends installed on a frame and a roll screen wound around the inside of the guide to be withdrawn from the guide or stored in the guide, in which the guide is slidable in a longitudinal direction of a vehicle.

### CROSS-REFERENCE TO RELATED APPLICATION

This application claims priority to and the benefit of Korean Patent Application No. 10-2021-0151534, filed on Nov. 5, 2021, which is incorporated herein by reference in its entirety.

### BACKGROUND OF THE DISCLOSURE

### Field of the Disclosure

The present disclosure relates to a bidirectional window screen for a vehicle that can be independently deployed forward and backward, respectively, while moving in a longitudinal direction of a vehicle.

### Description of Related Art

A vehicle traveling outdoors is equipped with various devices for blocking some or all of sunlight.

For example, as shown in FIGS. 1 and 2, a door curtain 121 or a window screen 122 may be installed on the window in a bus on which many passengers board, and the passengers deploy the door curtain 121 or the window screen 122 to block the sunlight.

The door curtain 121 shown in FIG. 1 has one end of the door curtain 121 fixed to a pillar 112 of the vehicle and the other end of the door curtain 121 installed to be deployed away from the pillar 112. In some cases, an interval or location of a seat 111 does not match with a location of the pillar 112, and therefore, an operation of the door curtain 121 may be inconvenient depending upon the seat 111. For example, in FIG. 1, a passenger on the No. \textcircled{2} seat is far away from the pillar 112 and therefore, it may be inconvenient for the passenger to operate the door curtain 121. In addition, the distinction between a particular seat and the door curtain 121 is ambiguous, thereby causing inconvenience between front passengers and rear passengers. A passenger on the No. \textcircled{1} seat of FIG. 1 should deploy all of the door curtains 121 of the front passenger's seat and the rear passenger's seat to fully block the sunlight. However, since the front passenger or rear passenger with respect to the No. \textcircled{1} seat may not want to do it (i.e., may not want the door curtains 121 to be deployed), he/she can be dissatisfied with the use of the door curtain 121.

FIG. 2 shows an example in which a window screen 122 is installed. The window screen 122 is installed on a window between two pillars 112 and is deployed from an upper end to a lower end of the window. Since a width of the window screen 122 corresponds to the interval between the pillars 112, there may be an inconvenience in that the passengers who share one window cannot individually operate the window screen (or even individually decide whether or not to operate the window screen). In other words, in FIG. 2, the passengers on the No. \textcircled{1} seat and the No. \textcircled{2} seat share the window screen 122, and therefore, the passengers on the No. \textcircled{1} seat and the No. \textcircled{2} seat cannot individually operate the window screen 122. In addition, the interval between the seats and the location of the pillar 112 do not match with each other, thereby causing an inconvenience between the front and rear passengers. In FIG. 2, if the passenger on the No. \textcircled{1} seat fully blocks the sunlight using the window screen 122, the front passenger of the No. \textcircled{1} seat and the passenger on the No. \textcircled{2} seat may have discomfort that the window screen 122 is deployed regardless of their intentions.

In particular, to secure beautiful sight and openness, a bus, for example, may have a larger interval between the pillars 112, and therefore, the aforementioned inconvenience may be increased when the door curtain 121 and the window screen 122 are used.

The contents described in the above Description of Related Art are to help the understanding of the background of the present disclosure, and may include what is not previously known to those having ordinary skill in the art to which the present disclosure pertains.

### SUMMARY OF THE DISCLOSURE

The present disclosure has been invented to solve the above problems. An object of the present disclosure is to provide a bidirectional window screen for a vehicle, which can be moved in a longitudinal direction of the vehicle and independently block light for each seat without any influence on other seats while being individually operated for each seat.

A bidirectional window screen for a vehicle according to the present disclosure for achieving this object includes a guide having upper and lower ends installed on a frame and a roll screen wound around the inside of the guide to be withdrawn from the guide or stored in the guide, in which the guide is slidable in a longitudinal direction of a vehicle.

The roll screen is withdrawn in the longitudinal direction of the vehicle.

The bidirectional window screen further includes: an upper rail installed on an upper end of the frame in a sliding direction of the guide; a lower rail installed on a lower end of the frame in the sliding direction of the guide; and moving blocks provided in the upper rail and the lower rail to be slidable. The upper and lower ends of the guide are coupled to the moving blocks, respectively, such that the guide is slidable.

The moving blocks are each formed with a bolt part protruding toward the guide. The upper and lower ends of the guide are formed with fixing grooves through which the bolt parts pass, respectively, and a fixing nut is fastened to the bolt parts passing through the fixing grooves. Therefore, the upper and lower ends of the guide are fixed to the moving blocks.

The guide is formed with a roll screen accommodation part configured to accommodate the roll screen wound in a height direction of the vehicle. One side of the guide is formed with a withdrawal slit through which the roll screen is withdrawn.

An end of the roll screen is formed with a shade bar configured to prevent the end of the roll screen from being accommodated in the roll screen accommodation part through the withdrawal slit, and to allow the end of the roll screen to maintain a constant form.

The shade bar is formed with a knob for operation of the roll screen.

A pillar of the vehicle is formed with an accommodation groove, and the knob is formed with a hook configured to lock to the accommodation groove when the roll screen is deployed.

The bidirectional window screen further includes a shaft rotatably installed on the roll screen accommodation part and having the roll screen wound thereon and a spring configured to provide an elastic force of winding the roll screen to the shaft.

The guide is formed with a plurality of roll screen accommodation parts in the longitudinal direction of the vehicle configured to accommodate a plurality of roll screens. Each of the plurality of roll screens is independently withdrawn toward the front and rear of the vehicle from the guide.

The bidirectional window screen further includes a cover configured to cover the guide on the indoor side of the vehicle side of the guide.

The guide has the upper and lower ends installed on the frame on which a window is installed.

According to the bidirectional window screen for the vehicle according to the present disclosure having the above configuration, the installation interval of the window screen and the installation interval of the seat can match with each other, thereby allowing individual use of the window screen for each seat.

In addition, it is possible to individually use the window screen, thereby not affecting the front and rear seats when the window screen is used.

In addition, if the interval between the seats is changed, the window screen can be rearranged depending upon the interval of the seats.

### BRIEF DESCRIPTION OF THE DRAWINGS

FIG. 1 is a schematic diagram showing a state where a door curtain is installed on a window according to the related art.

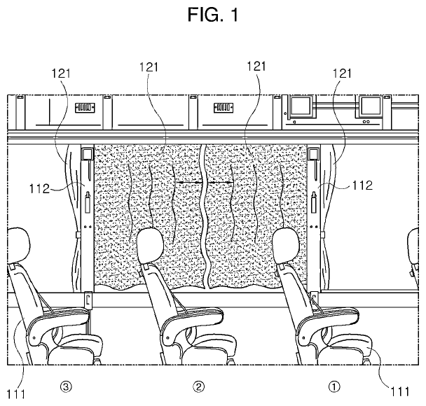

FIG. 2 is a schematic diagram showing a state where a window screen is installed on the window according to the related art.

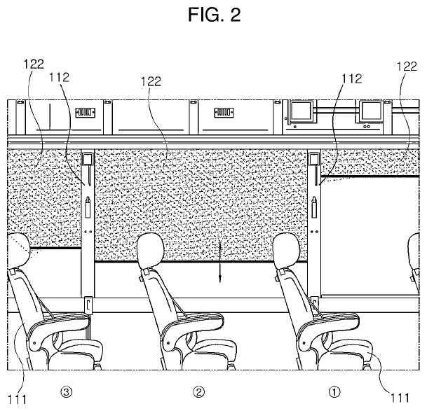

FIG. 3 is a perspective diagram showing a state where a roll screen is deployed from a bidirectional window screen for a vehicle according to the present disclosure.

FIG. 4 is a perspective diagram showing a state where the roll screen is stored in the bidirectional window screen for the vehicle according to the present disclosure.

FIG. 5 is a perspective diagram showing a state where a cover is separated from the bidirectional window screen for the vehicle according to the present disclosure.

FIG. 6 is a cross-sectional diagram of the bidirectional window screen for the vehicle according to the present disclosure.

FIG. 7 is an exploded perspective diagram showing a state where the roll screen is installed on a shaft in the bidirectional window screen for the vehicle according to the present disclosure.

FIG. 8 is a cross-sectional diagram showing a state where the roll screen is withdrawn from the bidirectional window screen for the vehicle according to the present disclosure.

FIG. 9 is a perspective diagram showing a state where a moving block is installed on an upper rail and a lower rail in the bidirectional window screen for the vehicle according to the present disclosure.

FIG. 10 is a schematic diagram showing a state where the moving block and a guide are assembled in the bidirectional window screen for the vehicle according to the present disclosure.

FIG. 11 is a schematic diagram showing a use state of the bidirectional window screen for the vehicle according to the present disclosure.

### DESCRIPTION OF SPECIFIC EMBODIMENTS

Hereinafter, a bidirectional window screen for a vehicle according to the present disclosure is described in detail with reference to the accompanying drawings.

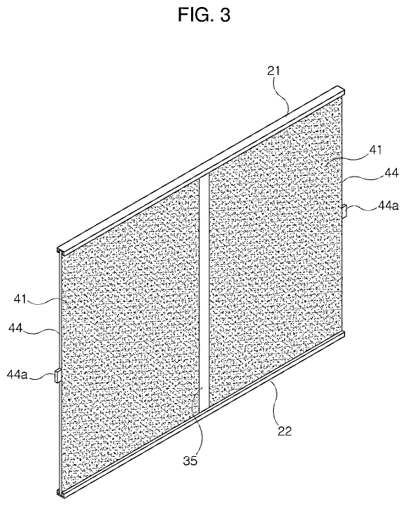

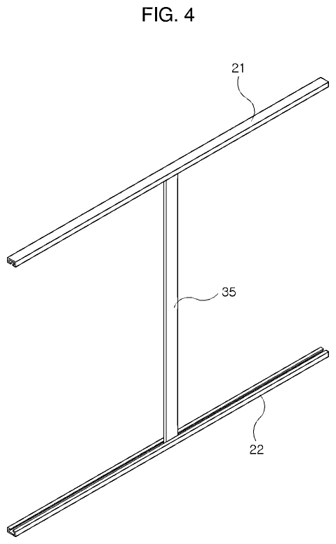

As shown in at least FIGS. 3-6, a bidirectional window screen for a vehicle according to the present disclosure includes a guide 30 having upper and lower ends installed on a frame, and a roll screen 41 wound around the inside of the guide 30 to be withdrawn from the guide 30 or stored in the guide 30. The guide 30 is slidable in a longitudinal direction of the vehicle.

The guide 30 is installed to have the upper and lower ends connected to the frame on which a window is installed. The guide 30 is formed in a height direction of the vehicle and formed to connect the upper and lower ends of the frame.

The roll screen 41 for blocking sunlight is accommodated in the guide 30, and withdrawn and deployed if necessary, thereby blocking the light.

The guide 30 is installed to be slidable in the longitudinal direction of the vehicle.

To be slidable, the guide 30 has an upper rail 21 and a lower rail 22 configured to guide the sliding of the guide 30 installed on the upper and lower ends of the frame, respectively.

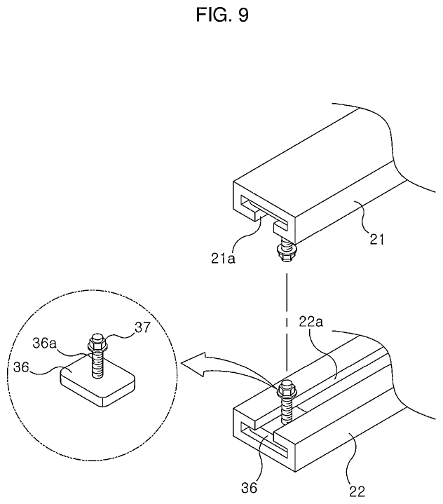

Referring to FIG. 9, the inside of the upper rail 21 is formed in a hollow shape, and the upper rail 21 is formed with a slit 21a having an opened lower end. The upper rail 21 and the lower rail 22 have the same forms and are installed in a vertically inverted form (i.e., symmetrical with respect to each other). Therefore, the inside of the lower rail 22 is also formed in a hollow shape in the longitudinal direction of the vehicle and formed with a slit 22a having an opened upper end.

Moving blocks 36 sliding along the upper rail 21 and the lower rail 22 are installed on the upper rail 21 and the lower rail 22. The moving blocks 36 are fixed to the upper and lower ends of the guide 30, respectively, allowing the guide 30 to slide on the upper rail 21 and the lower rail 22.

The moving blocks 36 have a main body accommodated in the upper rail 21 and the lower rail 22, i.e., in the slits 21a, 22a. Additional moving blocks 36 may also be accommodated in the slit 21a or the slit 22a.

The moving blocks 36 are fastened to the upper and lower ends of the guide 30, so that the guide 30 is slidable on the window.

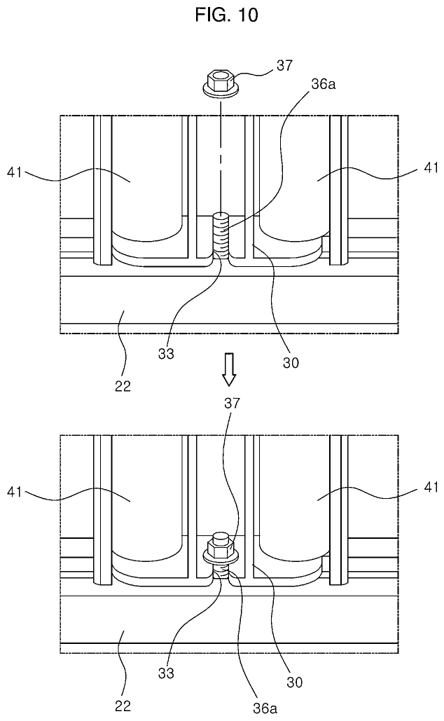

The moving blocks 36 are formed with a bolt part 36a to pass through the slits 21a, 22a. The bolt parts 36a of respective moving blocks 36 are fastened to corresponding upper and lower ends of the guide 30. In this way, the guide 30 can slide with the moving blocks 36. As shown in FIG. 10, the upper and lower ends of the guide 30 are formed with a fixing groove 33 so that the bolt part 36a can pass through it. A fixing nut 37 is fastened to the bolt part 36a passing through the fixing groove 33 in a screw-coupling manner, and therefore, the moving blocks 36 are installed on the upper and lower ends of the guide 30, respectively. As described above, since the moving blocks 36 are fastened to the upper and lower ends of the guide 30, respectively, the guide 30 becomes slidable in the longitudinal direction of the vehicle.

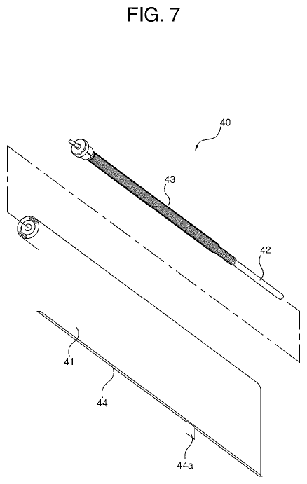

As shown in FIG. 7, a roll screen unit 40, including the roll screen 41, a shaft 42, and a spring 43, is withdrawn and deployed when accommodated in the guide 30, thereby covering the window.

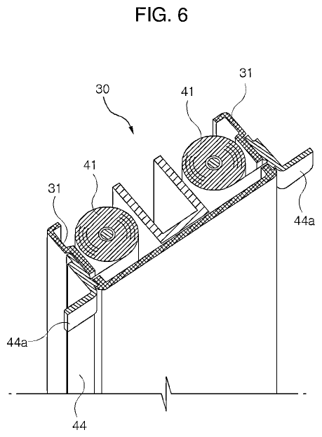

To this end, as shown in FIG. 6, the roll screen 41 is accommodated when wound around the inside of a roll screen accommodation part 31 formed on the guide 30. The roll screen 41 is accommodated in the roll screen accommodation part 31 when wound to be easily deployed when used, while having a minimum volume when not used.

The roll screen accommodation part 31 is formed in a vertical direction of the vehicle.

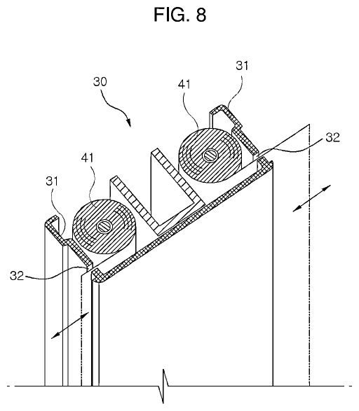

Referring to FIG. 8, one side of the roll screen accommodation part 31 is formed with a withdrawal slit 32 through which the roll screen 41 is withdrawn in the longitudinal direction of the vehicle. The roll screen 41 accommodated in the roll screen accommodation part 31 is withdrawn to the outside of the guide 30 through the withdrawal slit 32 while being sequentially released. Of course, when not using the roll screen 41, the roll screen 41 is stored in the roll screen accommodation part 31 through the withdrawal slit 32.

The roll screen 41 has a structure of a rollback screen type, and therefore, is automatically wound when stored. In other words, referring back to FIG. 7, the roll screen accommodation part 31 is provided with the rotatable shaft 42 around which the roll screen 41 is wound, and the spring 43 is configured to provide an elastic force in a direction in which the shaft 42 winds the roll screen 41. Therefore, to use the roll screen 41, the passenger withdraws the roll screen 41 at an operation force larger than the elastic force. In addition, to store the roll screen 41, the roll screen 41 is automatically wound by the elastic force of the spring 43 if the passenger releases the roll screen 41.

As shown in FIGS. 3 and 5-7, an end of the roll screen 41 is formed with a shade bar 44 configured to suppress the end of the roll screen 41 from entering the roll screen accommodation part 31 through the withdrawal slit 32. Thus, the end of the roll screen 41 maintains a constant form when the roll screen 41 is used. The shade bar 44 is formed at a thickness larger than a width of the withdrawal slit 32. Therefore, the end of the roll screen 41 maintains a state of being locked to the withdrawal slit 32 when the roll screen 41 is not used and may be easily withdrawn when the roll screen 41 is used.

In addition, the shade bar 44 is formed with a knob 44a configured to allow the passenger to perform an operation of grabbing the shade bar 44 and withdrawing the roll screen 41. The knob 44a may be a flange or any other type of projection or protuberance extending outward from the shade bar 44.

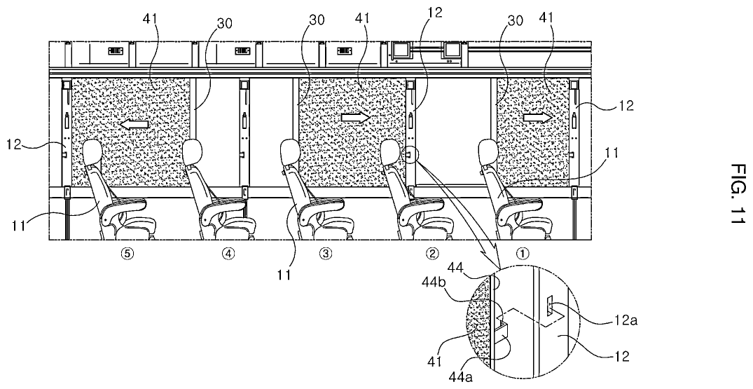

In addition, the shade bar 44 can be coupled to a pillar 12 or a member of the vehicle, which can be coupled to the shade bar 44 of another roll screen 41, such that both shade bars 44 may be withdrawn to face each other to maintain the state where the roll screens 41 are withdrawn. For example, as shown in FIG. 11, an end of the knob 44a may be formed with a hook 44b, and the pillar 12 may be formed with an accommodation groove 12a accommodating the hook 44b so that the hook 44b is locked to the accommodation groove 12a, thereby maintaining the state where the roll screens 41 are deployed.

Alternatively, the respective shade bars 44 of the respective roll screens 41 that are withdrawn to face each other may each be formed with the hooks fastened to each other, respectively, or each may be formed with the hook and the accommodation groove, respectively, to be locked to each other when the roll screens 41 are deployed, thereby maintaining the state where the roll screens 41 are deployed.

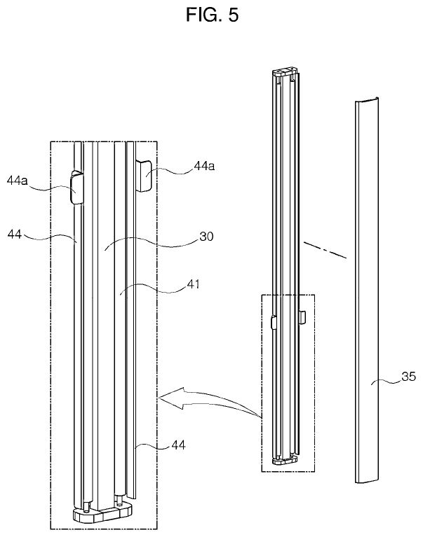

Referring to FIG. 5, the guide 30, on the indoor side of the vehicle, may be coupled with a cover 35 configured to cover one side of the guide 30. In other words, the cover 35 is configured to cover the guide 30 on the indoor side of the vehicle side of the guide 30 (i.e., the side of the guide 30 facing the inside of the vehicle).

The operation of the bidirectional window screen for the vehicle according to the present disclosure having the above configuration is described as follows.

According to the present disclosure, since the guide 30 is installed to be slidable in the longitudinal direction of the vehicle, the guide 30 is adjusted to fit a location of a seat 11 in the vehicle such as a bus, so that the passenger withdraws and uses the roll screen 41 when necessary.

The guide 30 may be configured to be located on a boundary portion of each seat 11. Since the roll screen 41 can be independently withdrawn to the front and rear of the vehicle, respectively, from the guide 30, a passenger on a seat 11 in front of the guide 30 and a passenger on a seat 11 in the rear of (i.e., behind) the guide 30 can freely deploy and use the roll screen 41 when the guide 30 is located on the boundary portion of each seat.

In FIG. 11, the guide 30 is located adjacent to a backrest of the No. \textcircled{3} seat 11. Since the roll screens 41 are independently withdrawn to the front and rear of the vehicle, respectively, from the guide 30, even if a passenger on the No. \textcircled{3} seat withdraws and uses the roll screen 41, it does not affect passengers on the No. \textcircled{2} and No. \textcircled{4} seats located to the front and rear thereof.

In such a manner, the passengers on the No. \textcircled{1} to \textcircled{5} seats can freely withdraw and use the roll screens 41 while not affecting each other.

In addition, since the guide 30 can be moved in the longitudinal direction of the vehicle, the roll screen 41 can be withdrawn, deployed, and used at the optimal location by moving forward or backward the guide 30 from the current location in an incident direction of sunlight.

In addition, if the interval between the seats 11 is changed, the guide 30 can be moved in response thereto so that the roll screen 41 can be deployed at the optimal location.

What is claimed is:

1. A bidirectional window screen for a vehicle comprising:
a guide having upper and lower ends installed respectively on a frame; and
a roll screen wound around the inside of the guide to be withdrawn from the guide or stored into the guide,
wherein the guide is slidable in a longitudinal direction of a vehicle.

2. The bidirectional window screen of claim 1,
wherein the roll screen is withdrawn in the longitudinal direction of the vehicle.

3. The bidirectional window screen of claim 1, further comprising:
an upper rail installed on an upper end of the frame in a sliding direction of the guide;
a lower rail installed on a lower end of the frame in the sliding direction of the guide; and
moving blocks provided respectively in the upper rail and the lower rail to be slidable,
wherein the upper and lower ends of the guide are coupled to the moving blocks, respectively, such that the guide is slidable.

4. The bidirectional window screen of claim 3, further comprising:
a bolt part protruded in each of the moving blocks toward the guide; and
fixing grooves, through which the bolt parts pass, formed at the upper and lower ends of the guide, respectively,
wherein a fixing nut is fastened to the bolt part passing through the fixing groove, such that the upper and lower ends of the guide are fixed to the moving blocks.

5. The bidirectional window screen of claim 1,
wherein the guide comprises:
a roll screen accommodation part configured to accommodate the roll screen wound in a height direction of the vehicle; and
a withdrawal slit, through which the roll screen is withdrawn, formed at one side of the guide.

6. The bidirectional window screen of claim 5,
wherein the roll screen comprises a shade bar disposed at an end of the roll screen, the shade bar being configured to prevent the end of the roll screen from being accommodated in the roll screen accommodation part through the withdrawal slit, and to allow the end of the roll screen to maintain a constant form.

7. The bidirectional window screen of claim 6,
wherein the shade bar comprises a knob for operation of the roll screen.

8. The bidirectional window screen of claim 7, further comprising:
an accommodation groove formed in a pillar of the vehicle, and
wherein the knob comprises a hook configured to lock to the accommodation groove when the roll screen is deployed.

9. The bidirectional window screen of claim 5, further comprising:
a shaft rotatably installed on the roll screen accommodation part and having the roll screen wound thereon; and
a spring configured to provide an elastic force of winding the roll screen to the shaft.

10. The bidirectional window screen of claim 5,
wherein the guide further comprises a plurality of roll screen accommodation parts in the longitudinal direction of the vehicle configured to accommodate a plurality of roll screens, and
wherein each of the plurality of roll screens is independently withdrawn toward the front and rear of the vehicle from the guide.

11. The bidirectional window screen of claim 1, further comprising:
a cover configured to cover the guide on the indoor side of the vehicle side of the guide.

12. The bidirectional window screen of claim 1,
wherein the guide has the upper and lower ends installed on the frame on which a window is installed.
